(19) United States
(12) Patent Application Publication
(10) Pub. No.: US 2002/0172911 A1
(43) Pub. Date: Nov. 21, 2002

(54) Inline orthodontics system and methods

(75) Inventor: Ronald B. Cooper, Atlanta, GA (US)

Correspondence Address: GREENBERG-TRAURIG, 1750 TYSONS BOULEVARD, 12TH FLOOR, MCLEAN, VA, 22102, US

(73) Assignee: Inline Dental, Inc., Atlanta, GA

(21) Appl. No.: 10/120,824

(22) Filed: Apr. 12, 2002

Related U.S. Application Data
(60) Provisional application No. 60/283,185, filed on Apr. 12, 2001.

(51) Int. Cl. A61C 3/00

(52) U.S. Cl. 433/24

(57) ABSTRACT

A system enabling the delivery of malocclusion correction devices to the general dental community under the supervision of an orthodontist. Based on a treatment plan developed by the orthodontist, a prescription will be entered into the inventive entry order software, and the prescription will be transmitted to a malocclusion correction device laboratory through the Internet. The system and procedures allow a dentist to virtually communicate with an orthodontist assigned to the patient's case. Additionally, the system and methods provides many ancillary services such as credit applications, loan processing and payments to be performed online between a dentist, a bank and insurance companies.

This application claims priority to U.S. Provisional Patent Application Serial No. 60/283,185 entitled “Inline Orthodontics System and Methods” filed Apr. 12, 2001, the teachings of which are herein incorporated by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

This invention relates to a system and procedures for collecting data and information via the internet from a network of selected healthcare participants. More particularly, the present invention relates to the field of orthodontic products and services for providing a platform to communicate with and pass data between a dental network, an orthodontic network, and a business services provider company such as Inline Orthodontics and an orthodontic product provider such as Align Technology, Inc.

### BACKGROUND OF THE INVENTION

There is a need in the dental health profession to allow general dentists to provide orthodontic care for their patients. Such a need is provided by a business services provider company, such as Inline Orthodontics, which provides an extranet site for the dental and orthodontic communities for the purpose of facilitating the implementation of the newly developed Invisalign clear braces system from Align Technology of Santa Clara, Calif. Invisalign products were designed to be distributed to orthodontics for their use with patients. Orthodontists may analyze and prescribe orthodontic treatment for their patients using the Invisalign product. Inline Orthodontics as a service provider will provide web technology as a medium in which the general dentists can gather necessary patient case information and electronically pass the information to a contract orthodontist for diagnosis and treatment planning, therefore, allowing general dentists to provide the Invisalign or similar malocclusion correction devices to their patients.

### SUMMARY OF THE INVENTION

Inline Orthodontics has created a system and methods including unique software that web enables the delivery of the Invisalign product to the general dental community. Via the world wide web, Inline Orthodontics, as a business services provider, allows the general dental community direct access to an application server running proprietary software that will transport case specific information to an orthodontist for case review, diagnosis and treatment planning. The web enabled software allows the orthodontist to use advanced technology to virtually review the dental case and prescribe a plan for treatment. Based on the treatment plan developed by the orthodontist, a prescription will be entered into the Inline Orthodontic entry order software, and the prescription will be transmitted to Align Technology laboratories. The prescription will become an order for patient specific, customized Invisalign braces. The development and use of Inline Orthodontic web enabled software and procedures will allow the dentist to virtually communicate with an Orthodontist assigned to the patient's case.

In addition, the unique software provides many ancillary services such as credit applications, loan processing and payments between the dentist, bank and insurance company to be performed online.

### BRIEF DESCRIPTION OF THE DRAWINGS

FIG. 1 is a system use case diagram showing in block diagram form a the relationship between different parties on the system.

FIG. 2 is a flow diagram which illustrates the order and associated information in a typical implement of the invention.

### DETAILED DESCRIPTION OF THE PREFERRED EMBODIMENT

The inventive system and method is an innovative business process that utilizes new technologies and techniques in a cosmetic-focused general dental office to provide patients with a single access point for specialty aesthetic orthodontic services. The focus is primarily on adult orthodontic correction, but is Federal Drug Administration approved to work on all ages of dental patients. This creates a tightly focused goal alignment between a general dental practitioner and on-site orthodontic care to secure patients for high margin orthodontic services and generate above average returns through high volume synergies of market development and internet interactivity.

Co-management of these orthodontic cases using the Invisalign product allows the general dentist to maintain ownership of the patient relationship and offer high-margin adult cosmetic services as well as offer more opportunities to provide ancillary related cosmetic dentistry services such as whitening, veneers and filling replacements. The patient is served by the convenience of a local dentist's office and yet obtains expert orthodontic diagnostics and treatment review.

The business services provider, Inline Orthodontics, provides a general dentist with a complete set of equipment, marketing support, training, patient education and patient financing necessary to deliver the Invisalign product. Inline Orthodontics is a teleconsulting orthodontic specialty company formed by a group of leading orthodontists to provide management services to general dentist practitioners.

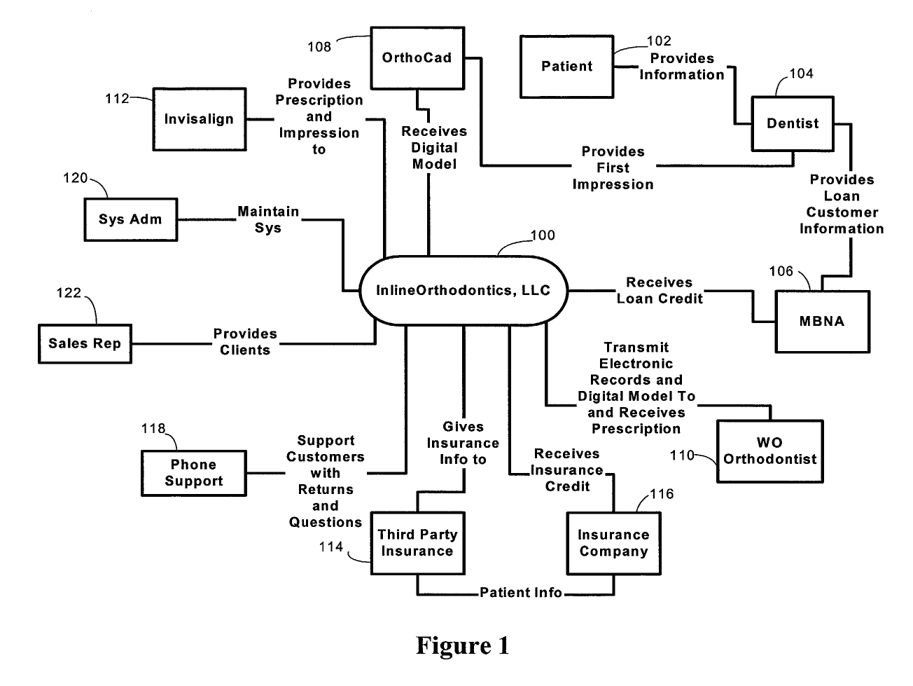

Referring to FIG. 1, using the inventive system and methods a business service provider 100, allows a patient 102, to be directed by a dentist 104, to access a customized application software to complete loan applications, insurance information and personal demographic information that will be passed to third party vendors 106, for processing. Denial and acceptance of financial information will be returned to the company 100, and communicated to the patient 102, via the invention. The dentist will follow industry standard regulations for gathering case information, in addition he/she will use the Inline Orthodontics' system and methods to prepare the case information for entry into the company's application server. The case information is digitized in the dental office with or without the aid of a third party vendor, such as Orthocad 108, and processed by use of the invention on the company's application server where it is distributed by the system using appropriate privacy and security rules to a designated orthodontist 110, for review. Using the inventive system, the orthodontist 110, will review the case information, diagnosis the case and prescribe treatment. The treatment prescription is transmitted for product fulfillment to Invisalign 112, via the present invention. The Invisalign product is processed, tracked using the invention and distributed to the dental office where the dentist 104, will implement treatment using the product. Treatment progress is monitored by the orthodontist 110, via the invention.

Patient insurance information gather may be sent to employer insurance administrator 114, who interfaces with insurance company 116, to provide insurance payment to the business service provider 100. The business service provider then distributes the proceeds according to a pre-negotiated formula.

The invention contemplates telephone support 118 for the system and procedures. System administrators monitor and maintain the inventive system and method 120. Marketing and sales of orthodontic procedures and devices is provided within the system through sales representative 122.

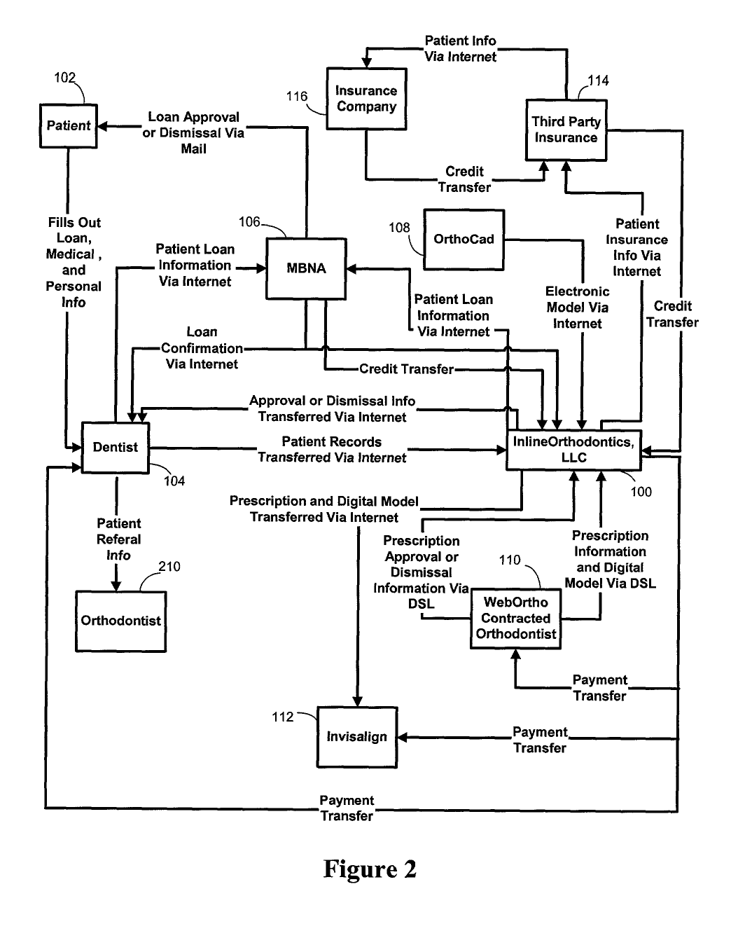

The order flow is illustrated in FIG. 2. The order flow follows the same general description given above. Shown in the illustrative diagram, in addition to the Inline Orthodontist contracted orthodontist 110, an outside orthodontist 210, may be referred to the patient by the general dentist 104. In the figure, business service provider 100, provides a system and method for a patient 102, to obtain dental health care from a general dentist 104. Patient information is provided as to medical history, personal information, insurance carriers and credit history. The credit information can be used by a bank 106, to process a loan. The dentist 104, takes an electronic model of the patients teeth via orthocad or other modeling means 108. The patient records are transmitted to the service provider 100 and on to a contracted orthodontics 110 for prescription approval. Upon approval, the prescription is sent in digital format to a malocclusion correction device manufacturer, such as Invisalign 112.

Insurance payment requests may be submitted electronically to the patient's employer for insurance reimbursement and processing, block 114. The dental insurance company 116, can transfer credit to the patient or the business service provider.

While the preferred embodiment and various alternative embodiments of the invention have been disclosed and described in detail herein, it will be apparent to those skilled in the art that various changes in form and detail may be made therein without departing from the spirit and scope thereof.

What is claimed is:

1. A system for providing orthodontia to general dentists using a global computer network, comprising:
dental patient information gathering means including the digital modeling of a patient's teeth;
creation of a malocclusion correction prescription based on the digital model of the patient's teeth;
transmission of the digital model and prescription to a manufacturer of orthodontia devices;
delivery to a general dentist the orthodontia device manufactured according to the digital model and prescription; and
treatment of the patient by the general dentist using the orthodontia device to straighten the patient's teeth.

2. A method for providing orthodontia to general dentists using a global computer network, comprising the steps of:
gathering dental patient information including the digital modeling of a patient's teeth;
creating a malocclusion correction prescription based on the digital model of the patient's teeth;
transmitting the digital model and prescription to a manufacturer of orthodontia devices;
delivering to a general dentist the orthodontia device manufactured according to the digital model and prescription; and
treating the patient by the general dentist using the orthodontia device to straighten the patient's teeth.
